(19) United States
(12) Patent Application Publication
(10) Pub. No.: US 2011/0256813 A1
(43) Pub. Date: Oct. 20, 2011

(54) COATED CARRIER FOR LAPPING AND METHODS OF MAKING AND USING

(76) Inventors: Timothy D. Fletcher, Lino Lakes, MN (US); Todd J. Christianson, Oakdale, MN (US); Vincent D. Romero, Maplewood, MN (US)

(21) Appl. No.: 13/141,596

(22) PCT Filed: Dec. 29, 2009
(86) PCT No.: PCT/US09/69672

§ 371 Date: Jun. 22, 2011

Related U.S. Application Data
(60) Provisional application No. 61/141,696, filed on Dec. 31, 2008.

(51) Int. Cl. B24B 37/04; C09K 3/14; B24B 41/06

(52) U.S. Cl. 451/59; 451/398; 51/298

(57) ABSTRACT

A lapping carrier (110) including a base carrier (112) having first and second major surfaces and at least one aperture for holding a workpiece extending from the first major surface to the second major surface, the aperture circumference defined by a third surface of the base carrier, at least a portion of the first and/or second major surfaces including a polymeric region having at least the following adhesion promoting layers: (a) a primer layer (116) including at least one of a phenolic resin or a novolac resin; (b) a tie layer(115) adjoining the primer layer(116), the tie layer(115) including at least one of an amino-functional epoxy resin or a hydroxyl-functional epoxy resin; and (c) a polymeric layer (114) adjoining the tie layer (115) on a side opposite the primer layer(116), the polymeric layer(116) including an isocyanate-functional polymer. Also described are methods of making and using the carrier.

### CROSS REFERENCE TO RELATED APPLICATION

This application claims the benefit of U.S. Provisional Patent Application No. 61/141,696, filed Dec. 31, 2008, the disclosure of which is incorporated by reference herein in its entirety.

### TECHNICAL FIELD

This disclosure relates to lapping carriers and methods of lapping including methods using such carriers.

### BACKGROUND

A need often arises to grind or polish flat workpieces such as disk-shaped articles, e.g., silicon wafers, sapphire disks, optical elements, glass or aluminum substrates for magnetic recording devices, and the like, such that the two major surfaces are both parallel and free from significant scratches. Such grinding or polishing operations, differing in the rate of material removal and final surface finish, may be referred to collectively as lapping. A typical machine used for finishing the disks includes two superposed platens respectively disposed over and under one or more of the disks, so that opposing surfaces of the disks can be ground or polished simultaneously.

Moreover, the lapping machine may include carriers that position and retain the disks during the grinding or polishing operation. Such carriers may be adapted to rotate relative to the platens. For example, the lapping machine may also include an outer ring gear, disposed around an outer periphery of the platens, and an inner gear, that projects through a hole formed in a center of the platens. The carriers can have a toothed outer periphery, which engages with the teeth or pins of the outer ring gear and the teeth or pins of the inner gear. Rotation of the inner gear and outer gear in opposite directions, for example, thus causes the carrier to rotate globally around the inner gear, and about an axis of the carrier.

Typically, the manufacturer of the single- or double-sided finishing machine will polish the surfaces of the platens using a lapping technique, prior to the polishing machine being shipped to the end user. It is conventionally believed that the lapping technique provides the platens with a relatively flat and planar surface suitable for most polishing operations. To polish the workpieces, a polishing slurry is provided on a surface of the disks. The platens are brought together to exert a predetermined pressure upon the workpieces, and the carriers and workpieces are rotated, thus planarizing, polishing and/or thinning the surfaces of the workpieces. Recently, fixed abrasive articles disposed over the working surfaces of the platens have been employed to reduce maintenance costs and the accompanying unproductive time associated with periodic dressing of the platens to the necessary degree of flatness and coplanarity.

It has further been observed that during the polishing of glass disks, for example, that the teeth of the carriers tend to wear prematurely. In fact, the teeth can become so worn that they will shear off from the carrier, causing the lapping machine to become inoperative (i.e., a so-called mid-cycle crash). As will be appreciated, since the carriers are relatively expensive, a long life is desirable. Moreover, mid-cycle crashes require that the polishing machine be removed from service for an extended period of time, thus reducing throughput and increasing the cost of operations.

### SUMMARY

Several problems have been encountered when using fixed abrasives in dual-sided lapping applications. As the carriers contact the fixed abrasive under the pressure and relative motion associated with the lapping process, asymmetrical polishing can occur. Asymmetrical polishing is when one or more polishing characteristics, such as workpiece removal rate, are not identical between the upper surface and lower surface of the workpiece being polished. When using a fixed abrasive, this effect has been attributed to the dulling of the fixed abrasive by its contact with the carrier. In addition to dulling of the abrasive, a second problem associated with contact between the abrasive and the carrier is excessive wear of the carrier. Carrier wear may make the carriers so thin that they are not usable because of bending or tearing.

Current solutions to the problem of dulling of fixed abrasives by carrier materials and the resulting asymmetrical polishing performance include periodic conditioning of the fixed abrasive and the use of alternative carrier materials. During conditioning of the fixed abrasive, a second abrasive is brought into contact with the fixed abrasive under load and relative motion to wear away the portion of the fixed abrasive that has been affected by the carrier material. This technique relies on consuming the fixed abrasive to compensate for the degradation caused by the carrier—fixed abrasive interaction. Consuming the fixed abrasive by conditioning reduces the number of workpieces that can be ground with the abrasive which may limit the maximum value of the abrasive article. The reduction in process throughput because of the additional process step (conditioning) is also undesirable. In some instances, fixed abrasive still may need conditioning to achieve a desirable pad flatness.

The use of alternative carrier materials has typically involved using polymeric materials such as phenolics or epoxies to replace the stainless steels often used to produce carriers. Since the carrier must be as thin as or thinner than the workpiece to allow simultaneous lapping of both surfaces, there are limits on the overall thickness of the carrier. When the workpieces become thin (up to about 1 mm thickness) and large in diameter (e.g., at least about 150 mm) the carriers made from polymeric materials become too flexible for use, e.g., bending causes a mid-cycle crash or the workpieces to be broken. Fiber reinforcing materials such as glass are sometime used to increase the modulus of the polymeric carrier materials. However, the glass fibers can also cause a dulling of fixed abrasive.

It has been found that coating or laminating protective layers of a polymer, in some embodiments preferably a urethane resin, on the working surfaces of a metal carrier provides the dual benefits of greatly reducing the dulling of the fixed abrasive articles and of extending the life of the carrier. In so far as abrasive dulling may also be a problem in single-sided lapping operations, some embodiments of the invention include carriers in which the coating or layer is present only on the surface of the carrier which contacts the abrasive surface of the lapping machine.

In one aspect, the disclosure relates to a lapping carrier comprising a base carrier having a first major surface, a second major surface and at least one aperture for holding a workpiece, said aperture extending from the first major surface through the base carrier to the second major surface, wherein the circumference of said aperture is defined by a third surface of the base carrier, and further wherein at least a portion of the first major surface or at least a portion of each of the first and the second major surfaces comprises a polymeric region, said polymeric region comprising at least the following adhesion promoting layers:
(a) a primer layer, wherein the primer layer comprises at least one of a phenolic resin or a novolac resin;
(b) a tie layer adjoining the primer layer, wherein the tie layer comprises at least one of an amino-functional epoxy resin or a hydroxyl-functional epoxy resin; and
(c) a polymeric layer adjoining the tie layer on a side opposite the primer layer, wherein the polymeric layer comprises an isocyanate-functional polymer.

In some exemplary embodiments, both the first and second major surfaces comprise the polymeric region. In other exemplary embodiments, at least a portion of the third surface comprises the polymeric region. In certain particular exemplary embodiments, the base carrier comprises metal, glass, filled polymer, or ceramic.

In further exemplary embodiments, the primer layer comprises a novolac resin selected from a catechol novolac resin, a cresol novolac resin, a polyhydroxyphenol-endcapped novolac resin, or combinations thereof. In some exemplary embodiments, the primer layer comprises a phenolic resin selected from a cresol phenolic resin, a resol phenolic resin, a polyhydroxy phenolic resin, a hydroxythiophenol phenolic resin, a polythiol phenolic resin, or combinations thereof. In certain presently preferred embodiments, the primer layer is chemically bonded to at least one of the base carrier or the tie layer. In additional presently preferred embodiments, the tie layer is chemically bonded to at least one of the primer layer or the polymeric layer.

In additional exemplary embodiments, the at least one amino-functional epoxy resin or hydroxyl-functional epoxy resin is a poly-functional epoxy resin. In certain additional exemplary embodiments, the isocyanate-functional polymer comprises a poly-functional urethane polymer. In particular exemplary embodiments, the isocyanate-functional polymer comprises a crosslinked urethane polymer.

In additional exemplary embodiments, the polymeric region or layer comprises a polymeric coating or a laminated polymeric film. In other exemplary embodiments, at least one of the primer layer, the tie layer, or the polymeric layer comprises a dried and cured film. In certain exemplary embodiments, the polymeric region or layer has a work to failure of at least about 15 Joules. In particular exemplary embodiments, the polymeric region or layer includes a thermoset polymer, a thermoplastic polymer, a thermoset polyurethane, a thermoplastic polyurethane, or a combination thereof.

In another aspect, the disclosure relates to a method of lapping using the above-described double-sided coated carrier embodiments, the method comprising:
(a) providing a double-sided lapping machine having two opposed lapping surfaces or a single-sided lapping machine;
(b) providing the carrier of any of the above descriptions, comprising a base carrier having a first major surface, a second major surface and at least one aperture for holding a workpiece, said aperture extending from the first major surface through the base carrier to the second major surface, wherein the circumference of said aperture is defined by a third surface of the base carrier, and further wherein at least a portion of the first major surface or at least a portion of each of the first and the second major surfaces comprises a polymeric region, said polymeric region comprising at least the following adhesion promoting layers:
   (1) a primer layer, wherein the primer layer comprises at least one of a phenolic resin or a novolac resin;
   (2) a tie layer adjoining the primer layer, wherein the tie layer comprises at least one of an amino-functional epoxy resin or a hydroxyl-functional epoxy resin; and
   (3) a polymeric layer adjoining the tie layer on a side opposite the primer layer, wherein the polymeric layer comprises an isocyanate-functional polymer;
(c) providing a workpiece;
(d) inserting the workpiece into the aperture;
(e) inserting the carrier into the lapping machine;
(f) providing relative motion between the workpiece and the lapping surface while maintaining contact between the lapping surface and the workpiece; and
(g) removing at least a portion of the workpiece.

In some exemplary embodiments, a working fluid is provided at the interface between the workpiece and the lapping surfaces, optionally wherein the working fluid comprises abrasive particles. In certain exemplary embodiments, the lapping machine is a double-sided lapping machine having two opposed lapping surfaces and further comprising providing relative motion between the workpiece and the two opposed lapping surfaces while maintaining contact between the lapping surfaces and the workpiece. In other exemplary embodiments, at least one of the two opposed lapping surfaces comprises a three-dimensional, textured, fixed-abrasive article. In further exemplary embodiments, the three-dimensional, textured, fixed-abrasive article comprises diamond particles and/or agglomerates disposed in a binder. In additional exemplary embodiments, at least one of the two opposed lapping surfaces comprises pellet laps.

In yet another aspect, the disclosure relates to a method of making a coated lapping carrier comprising:
(a) providing a base carrier having a first major surface, a second major surface and at least one aperture for holding a workpiece, said aperture extending from the first major surface through the base carrier to the second major surface, wherein the circumference of said aperture is defined by a third surface of the base carrier;
(b) applying a primer layer to at least one surface of the base carrier, wherein the primer layer comprises at least one of a phenolic resin or a novolac resin;
(c) applying a tie layer adjoining the primer layer, wherein the tie layer comprises at least one of an amino-functional epoxy resin or a hydroxyl-functional epoxy resin; and
(d) applying a polymeric layer adjoining the tie layer, wherein the polymeric layer comprises an isocyanate-functional polymer.

In certain embodiments, at least one of the primer layer, the tie layer or the polymeric layer is applied from an organic solvent. In some exemplary embodiments, the method further comprises heating at least one of the primer layer, the tie layer or the polymeric layer to remove at least a portion of the organic solvent. In some presently preferred embodiments, at least one of the primer layer, the tie layer or the polymeric layer is applied by spray coating. In other exemplary embodiments, the polymeric layer is applied by laminating a polymeric film comprising the isocyanate-functional polymer to the tie layer.

In further exemplary embodiments, the primer layer, the tie layer and the polymeric layer are applied on at least a portion of both major surfaces. In some exemplary embodiments, the primer layer, the tie layer and the polymeric layer are applied on substantially the entire major surface of at least one major surface. In additional exemplary embodiments, the primer layer, the tie layer and the polymeric layer are applied to the entire major surface of both major surfaces.

In additional exemplary embodiments, the tie layer is chemically reacted with at least one of the primer layer or the polymeric layer. In some particular exemplary embodiments, the tie layer is chemically reacted with both the primer layer and the polymeric layer. In certain exemplary embodiments, the primer layer comprises a novolac resin selected from a catechol novolac resin, a cresol novolac resin, a polyhydroxyphenol-endcapped novolac resin, or combinations thereof. In some exemplary embodiments, the primer layer comprises a phenolic resin selected from a cresol phenolic resin, a resol phenolic resin, a polyhydroxy phenolic resin, a hydroxythiophenol phenolic resin, a polythiol phenolic resin, or combinations thereof. In some particular exemplary embodiments, the at least one amino-functional epoxy resin or hydroxyl-functional epoxy resin is a poly-functional epoxy resin.

In certain additional exemplary embodiments, the isocyanate-functional polymer comprises a poly-functional urethane polymer. In particular additional exemplary embodiments, the isocyanate-functional polymer comprises a crosslinked urethane polymer. The isocyanate-functional polymer has, in some embodiments, a work to failure of at least about 15 Joules. In further exemplary embodiments, the polymeric layer comprises a thermoset polymer, a thermoplastic polymer, a thermoset polyurethane, a thermoplastic polyurethane, or a combination thereof. In additional exemplary embodiments, at least one of the primer layer, the tie layer, or the polymeric layer comprises a dried and cured film.

Various aspects and advantages of exemplary embodiments of the presently disclosed invention have been summarized. The above Summary is not intended to describe each illustrated embodiment or every implementation of the presently disclosed invention. The Drawings and the Detailed Description that follow more particularly exemplify certain preferred embodiments using the principles disclosed herein.

### BRIEF DESCRIPTION OF THE DRAWINGS

Exemplary embodiments of the present disclosure are further described with reference to the appended figures, wherein:

FIG. 1 is a workpiece carrier according to one exemplary embodiment of the present disclosure.

FIGS. 2a-2e are partial sections of workpiece carriers useful in double-sided lapping according to various embodiments of the present disclosure.

### DETAILED DESCRIPTION

Flat, single-sided lapping of substrates is a process that has been used for years in electronics and other industries. It is used to grind and/or polish one of the major surfaces of a variety of workpieces, for example, glass or metal disks used as substrates for magnetic recording coatings, semiconductor wafers, ceramic, sapphire, optical elements, and the like. It is generally desirable to achieve high degrees of both flatness and uniformity of thickness in addition to the preferred surface finish. Such single-sided lapping machines may use a variety of abrasive features or surfaces depending upon the characteristics desired.

In general, the workpiece is held in a fixture that is brought into contact with a platen under a specified load. The workpiece/fixture combination and the platen are then set into relative motion to achieve the desired amount of material removal. The workpiece/fixture combination may be rotating (due to friction or driven by a motor) or stationary. The platen may be rotation or stationary depending on the motion of the workpiece/fixture combination. The workpiece/fixture combination can also be moved laterally with respect to the rotating platen in order to facilitate both uniform removal of the workpiece and uniform wear of the platen.

The platen may be fabricated from or covered with a material suitable for slurry-based polishing. Alternatively, they may be fitted with buttons containing abrasive particles, often diamonds or other superabrasives, embedded in a rigid matrix. More recently a textured three-dimensional fixed abrasive article, such as Trizact™ Diamond Tile has been applied to the surface of the platen to provide the abrasive action.

Flat, double-sided lapping of substrates is becoming increasingly common in electronics and other industries. It is used to simultaneously grind and/or polish both major surfaces of a variety of workpieces, for example, glass or metal disks used as substrates for magnetic recording coatings, semiconductor wafers, ceramic, sapphire, optical elements, and the like. It is generally desirable to achieve high degrees of both flatness and uniformity of thickness in addition to the preferred surface finish. Such double-sided lapping machines may use a variety of abrasive features or surfaces depending upon the characteristics desired. The upper and lower platens may be fabricated from or covered with a material suitable for slurry-based polishing.

Alternatively, they may be fitted with buttons containing abrasive particles, often diamonds or other superabrasives, embedded in a rigid matrix. More recently a textured three-dimensional fixed abrasive article, such as Trizact™ Diamond Tile has been applied to the surface of the platens to provide the abrasive action.

Various exemplary embodiments of the disclosure will now be described with particular reference to the Drawings. Exemplary embodiments of the presently disclosed invention may take on various modifications and alterations without departing from the spirit and scope of the disclosure. Accordingly, it is to be understood that the embodiments of the presently disclosed invention are not to be limited to the following described exemplary embodiments, but is to be controlled by the limitations set forth in the claims and any equivalents thereof.

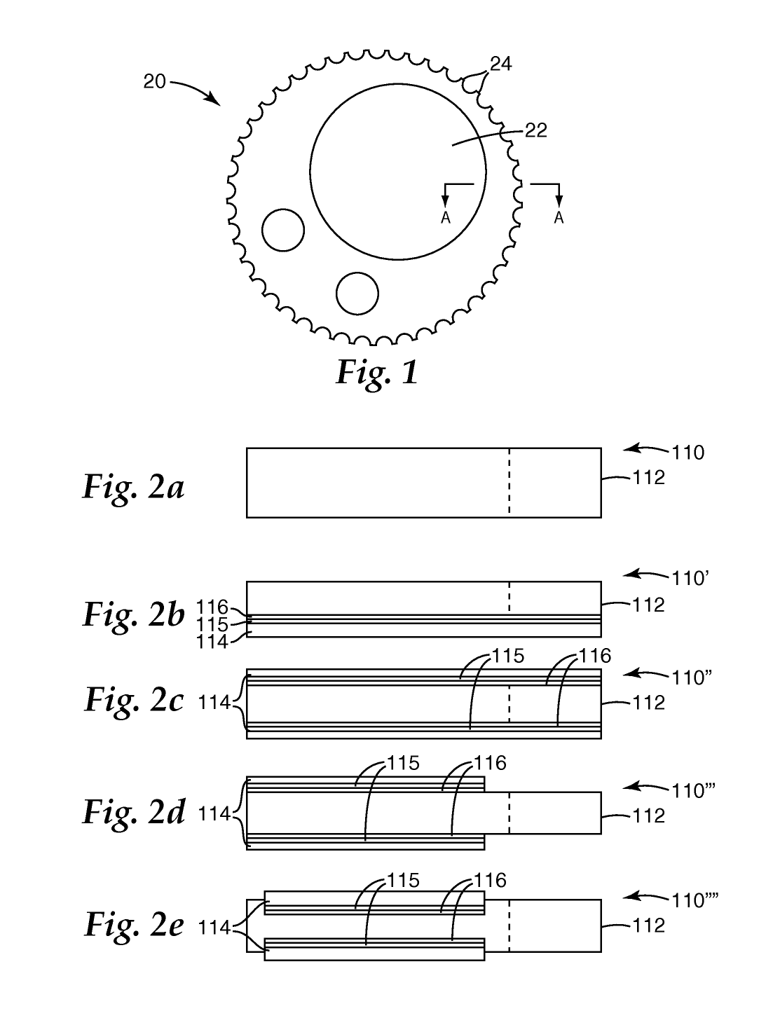

FIG. 1 illustrates a typical workpiece carrier for flat, dual side polishing or grinding. The workpiece is inserted into an aperture 22 in a carrier 20 which bears teeth 24 around the perimeter. The circumference of aperture 22 is defined by the surface area of the single support associated with the support thickness. In some instances, the circumference of the aperture in the support is fabricated to be larger and may be of a different shape than the required circumference and shape to hold a workpiece. An insert, having a second aperture of the desired circumference and shape to facilitate holding of the workpiece, may then be mounted in the support aperture.

Any known insert can be used, e.g., those described in U.S. Pat. No. 6,419,555. The insert typically comprises a different material from that of the support. The carrier teeth engage corresponding teeth or pins (not shown) disposed around an outer periphery of the platens, and an inner gear, sometimes referred to as a sun gear, that projects through a hole formed in a center of the platens. The carriers can then have a toothed outer periphery, which engages with the teeth or pins of the outer ring gear and the teeth or pins of the inner gear. Rotation of the inner gear and outer gear in opposite directions, for example, thus causes the carrier to rotate globally around the inner gear, and about an axis of the carrier. Carriers also can be designed to rotate about a platen using a sun gear and a ring gear, which may move in the same direction but at different speeds. FIG. 2a is illustrative of a cross-section corresponding to section A-A of FIG. 1 of a carrier 110 of the prior art which consists of a single support, i.e., base carrier 112, typically metal for rigidity. In certain exemplary embodiments, the base carrier may comprise glass, filled polymer, or ceramic.

FIG. 2b is illustrative of one exemplary embodiment of a single-sided coated carrier 110 comprising base carrier 112 and bearing on one major surface (the lower major surface is illustrated, although the opposite upper major surface may alternatively or additionally be used) a polymeric region comprising at least the following adhesion promoting layers (APL): (a) a primer layer 116; (b) a tie layer 115 adjoining the primer layer 116; and (c) a polymeric layer 114 adjoining the tie layer on a side opposite the primer layer 116, wherein the polymeric layer comprises an isocyanate-functional polymer. In the embodiment illustrated by FIG. 2b, the polymeric region is shown covering substantially the entire major surface of the base carrier 112. In some exemplary embodiments, the circumference of aperture 22 (FIG. 1) is defined by the surface area of the single support associated with the support thickness, and at least a portion of this third surface may additionally comprise the polymeric region.

FIG. 2c is illustrative of an alternative exemplary embodiment of a double-sided coated carrier 110′ in which the base carrier 112 bears on both major surfaces a polymeric region comprising at least the following adhesion promoting layers: (a) a primer layer 116; (b) a tie layer 115 adjoining the primer layer 116; and (c) a polymeric layer 114 adjoining the tie layer on a side opposite the primer layer 116, wherein the polymeric layer comprises an isocyanate-functional polymer. In the embodiment illustrated by FIG. 2c, the polymeric region is again shown covering substantially the entire major surface of the base carrier 112. In some exemplary embodiments, the circumference of aperture 22 (FIG. 1) is defined by the surface area of the single support associated with the support thickness, and at least a portion of this third surface may additionally comprise the polymeric region.

FIG. 2d is illustrative of another alternative exemplary embodiment of a double-sided coated carrier 110′″ in which the base carrier 112 bears on both major surfaces a polymeric region comprising at least the following adhesion promoting layers: (a) a primer layer 116; (b) a tie layer 115 adjoining the primer layer 116; and (c) a polymeric layer 114 adjoining the tie layer on a side opposite the primer layer 116, wherein the polymeric layer comprises an isocyanate-functional polymer. However, in the exemplary embodiment of a double-sided coated carrier 110′ illustrated by FIG. 2d, the coatings of polymeric layer 114 on each major surface of base carrier 112 do not cover the entire surface of the base carrier 112. In some exemplary embodiments, the circumference of aperture 22 (FIG. 1) is defined by the surface area of the single support associated with the support thickness, and at least a portion of this third surface may additionally comprise the polymeric region.

FIG. 2e is illustrative of yet another alternative exemplary embodiment of a double-sided coated carrier 110″″ in which the base carrier 112 bears on both major surfaces a polymeric region comprising at least the following adhesion promoting layers: (a) a primer layer 116; (b) a tie layer 115 adjoining the primer layer 116; and (c) a polymeric layer 114 adjoining the tie layer on a side opposite the primer layer 116, wherein the polymeric layer comprises an isocyanate-functional polymer. FIG. 2e illustrates an exemplary embodiment which maintains a greater thickness of the base carrier 112 in regions requiring greater mechanical stiffness, for example the region of the teeth and the region of contact with the workpiece. FIG. 2e also illustrates an exemplary embodiment which maintains a greater thickness of the polymeric layer 114 in regions requiring greater mechanical compliance, for example, the region of the solid body portion of the base carrier 112.

Although the embodiments of FIGS. 2b-2e indicate that substantially all of both major surfaces of the carrier, with the possible exception of the toothed region, are covered by the polymeric layers, it should be appreciated that the polymeric layers may be discontinuous in other embodiments and may be present in multiple regions on either or both major surfaces of the carrier. Continuous or discontinuous polymeric layers covering at least a portion of the major surfaces of the carrier may be desirable to optimize (e.g., reduce) the overall friction between the workpiece and carrier and the abrasive surfaces of the lapping platens and/or to provide enhanced flow of a working fluid for cooling, lubrication, chemical modification of the surfaces being abraded, swarf removal, and the like.

In further exemplary embodiments, the polymeric region comprises a polymeric coating or a laminated polymeric film. In certain exemplary embodiments, the polymeric region has a work to failure of at least about 15 Joules. In particular exemplary embodiments, the polymeric layer includes a thermoset polymer, a thermoplastic polymer, a thermoset polyurethane, a thermoplastic polyurethane, or a combination thereof.

In some embodiments, the polymeric region or layer may be textured to reduce contact drag or to improve working fluid flow. In some embodiments, the polymeric region or regions on one major surface of the carrier may be connected to the polymeric region or regions on the opposite major surface. In some embodiments a third surface, corresponding to the surface area of the base carrier defining the aperture circumference, may be at least partially coated by the polymer comprising the polymeric layers.

Suitable APL's may comprise a thermoset or thermoplastic polymer, including a thermoplastic polymer film. Such polymeric APL's may initially comprise monomers or oligomers that are polymerized and/or crosslinked after coating onto the appropriate surface. When applied to a substrate, the polymeric APL may be substantially one hundred percent in solids content or it may contain solvent that is substantially removed after coating. The polymeric APL may also be a polymer solution in which the solvent is substantially removed after coating. The polymeric APL may be polymerized and/or crosslinked after coating via standard techniques, including thermal curing and radiation curing. In certain presently preferred embodiments, the primer layer is chemically bonded to at least one of the base carrier or the tie layer. In additional presently preferred embodiments, the tie layer is chemically bonded to at least one of the primer layer or the polymeric layer.

In further exemplary embodiments, the primer layer comprises a novolac resin selected from a catechol novolac resin, a cresol novolac resin, a polyhydroxyphenol-endcapped novolac resin, or combinations thereof. In some exemplary embodiments, the primer layer comprises a phenolic resin selected from a cresol phenolic resin, a resol phenolic resin, a polyhydroxy phenolic resin, a hydroxythiophenol phenolic resin, a polythiol phenolic resin, or combinations thereof. Commercially available polymers or resin materials may be used in a primer layer in an APL. Chemlok™ 219, a phenolic resin available from Lord Corp. (Cary, N.C.), and Moleculok Diblend, an 80/20% w/w solution of a Phenolic Resin with a Cresol Catechol Novolac (CCN) resin in an organic solvent (3M Company, St. Paul, Minn.). Other suitable polymeric materials for use in a primer layer are described in U.S. Pat. Nos. 5,859,153 (Kirk et al.) and 6,911,512 B2 (Jing et al.).

In additional exemplary embodiments, the at least one amino-functional epoxy resin or hydroxyl-functional epoxy resin is a poly-functional epoxy resin. A suitable commercially available poly-functional epoxy resin useful as a tie layer material is Chemlok™ 213, an epoxy-urethane polymeric material available from Lord Corp. (Cary, N.C.).

In certain additional exemplary embodiments, the isocyanate-functional polymer comprises a poly-functional urethane polymer. In particular exemplary embodiments, the isocyanate-functional polymer comprises a crosslinked urethane polymer. In other exemplary embodiments, at least one of the primer layer, the tie layer, or the polymeric layer comprises a dried and cured film.

Selection of the polymeric regions or layer to enhance the performance of workpiece carriers used in double-sided lapping requires balancing several properties. The coated carrier must remain sufficiently rigid to drive the workpiece or workpieces between the abrasive platens while remaining thin enough to be used to lap the very thin workpieces desired in the electronics and related industries. Generally, it is desirable for the thickness of the carrier to be less than the desired final thickness of the workpiece. The polymeric layer should not cause undue dulling of the abrasive or undue wear of the abrasive surfaces which it contacts and it should be resistant to chemicals present in the working fluid.

In some embodiments, it is also desirable to avoid interactions with the abrasive which may lead to dulling. In still other embodiments, polymeric layers with substantial wear resistance are desirable. It has been found that materials which exhibit a large work to failure (also known as Energy to Break Stress), as demonstrated by a large integrated area under the stress versus strain curve, are particularly well suited as wear resistant materials in this application. It has been determined that polymers having a work to failure of at least about 5 Joules, at least about 10 Joules, at least about 15 Joules, 20 Joules, 25 Joules, 30 Joules, or even higher can be used as wear resistant polymeric layer for carriers.

The polymers comprising the polymeric region or layer may be a thermoset, a thermoplastic or combinations thereof. The thermoplastic polymers may include a class of polymers commonly referred to as thermoplastic elastomers. The polymers may be applied as a coating or as a laminated film. After applying the coating or film, further drying, annealing and/or curing of the coating or film may be required in order for the polymeric layer to reach its optimal utility. In some embodiments, the polymeric layers may comprise multiple layers of chemically distinct polymers.

In addition to possessing appropriate mechanical properties, the polymeric layers desirably should be able to withstand the chemical environment of the lapping operation without undue degradation of its properties. Polymers such as polyurethanes, epoxies, and certain polyesters typically have the desired chemical resistance to the working fluids employed and may be used as the polymeric layers. Preferred polymers comprising the polymeric layers or regions include thermoset polyurethanes, thermoplastic polyurethanes and combinations thereof. Polyurethanes formed from the reaction of hydroxyl terminated polyether or hydroxyl terminated polyester prepolymers with diisocyanates may be employed. Crosslinking of the polyurethane may be desirable. Crosslinking of the polyurethane may be achieved by conventional crosslinking reactions. One preferred crosslinking system is the reaction of a diisocyanate terminated polyurethane, such as Adiprene™ L83 available from Chemtura Corp. (Middlebury, Conn.), with an aliphatic or aromatic diamine, such as Ethacure™ 300 also available from Chemtura Corp. Thermoplastic polyurethane films, such as Estane™ 58219 available from Lubrizol Corp. (Wickliffe, Ohio) also may be used as the polymer layer of the present invention.

The organic coating can be applied to the base carrier and/or polymeric layer by conventional techniques including spray coating, dip coating, spin coating, roll coating, or coating with a brush or roller. Spray coating is presently preferred, preferably by spraying a polymer dissolved or dispersed in an organic solvent. Several adhesion promoting layers may be applied in sequence creating an adhesion promoting layer which comprises multiple layers.

Multiple pass spray coating, wherein each layer is allowed to partially dry before application of another layer, is particularly preferred. While not wishing to be bound by any particular theory, it is presently believed that a certain amount of residual solvent in one or more layers may be beneficial to facilitate interdiffusion and/or chemical reaction between the primer layer and the tie layer, and/or the tie layer and the polymer layer. The APLs may be combined in any desired layering sequence that facilitates the desired level of adhesion. Selection of the APL depends on a variety of factors including the composition of the base carrier and the composition of the polymeric layers. The order in which the various layers; base carrier, APL(s) and polymeric layer(s); of the lapping carrier are attached to one another may be selected based on achieving optimal utility of the lapping carrier and process considerations associated with applying the various layers. In some embodiments, the APL is first adhered to the base carrier followed by adhesion to the polymeric layer.

In other embodiments, the APL is first adhered to the polymeric layer followed by adhesion to the base carrier. In still other embodiments having a multi-layer APL, the APLs may be sequenced one above the other starting with the base carrier as the initial substrate or the APLs may be sequenced one above the other starting with the polymeric layer as the initial substrate. In some embodiments, one or more APLs may be applied in sequence to the base carrier and one or more APLs may be applied in sequence to the polymeric layer followed by joining of the outer most APL of the base carrier and polymeric layer. In some embodiments, a preferred multi-layer APL comprises a first adhesion promoting layer comprising a dried and cured C219 compound adjacent to a second adhesion promoting layer comprising a dried and cured C213 compound.

It is known that different lapping applications may require different levels of adhesion between the base carrier and the polymeric layer. A lapping process employing corrosive polishing solutions, high temperatures or having high degrees of shear transferred to the carrier may require higher adhesion between the base carrier and polymeric layers compared to a process employing less severe conditions. The selection of the adhesion promoting layers subsequently may depend on the lapping process conditions and or workpieces being abraded.

Prior to applying an APL to the base carrier surface or polymeric layer surface, it is often desirable to clean the surface. Conventional cleaning techniques may be employed, such as, washing the surface with a soap solution followed by rinsing with water or washing the surface with an appropriate solvent, e.g. methylethylketone, isopropanol or acetone, followed by drying. Depending on the composition of the carrier or polymeric layer, cleaning with an acid or base solution may also be useful. Sonication may also be used in conjunction with the above cleaning techniques. Additionally, plasma cleaning/surface contamination removal with argon as the gas is a preferred cleaning technique, particularly when the base carrier being coated is a metal, e.g., stainless steel.

In some embodiments, the base carrier comprises metal, glass, polymer, or ceramic. Preferred metals include steel and stainless steel. Preferred polymers include thermoset polymers, thermoplastic polymers and combinations thereof. The polymer may contain one or more fillers or additives, chosen for a specific purpose. Inorganic fillers may be employed to lower the cost of the carrier. Additionally, reinforcing fillers such as particles or fibers may be added to the polymer. Preferred reinforcing fillers are inorganic in nature and may comprise surface modification to improve the reinforcing effect. Nanoparticles, e.g. nanosilica, may also be of utility. The polymer may also contain layers or regions of reinforcing matting, typically woven materials, e.g. polymeric fiber matting, fiber glass matting or a metal screen.

In some embodiments, the base carrier and the polymeric region comprise different materials. In some embodiments, the polymeric regions comprise a polymeric coating or a laminated polymeric film. In some embodiments, each major surface of the carrier comprises two or more polymeric regions. In some embodiments, the regions comprise a urethane polymer, which can be a crosslinked polymer. In some embodiments, the polymer of the polymeric region has a work to failure of at least about 5, 15, 20, 25, Joules, or even higher.

In yet another aspect, the disclosure relates to a method of making a coated lapping carrier comprising:
(a) providing a base carrier having a first major surface, a second major surface and at least one aperture for holding a workpiece, said aperture extending from the first major surface through the base carrier to the second major surface, wherein the circumference of said aperture is defined by a third surface of the base carrier;
(b) applying a primer layer to at least one surface of the base carrier, wherein the primer layer comprises at least one of a phenolic resin or a novolac resin;
(c) applying a tie layer adjoining the primer layer, wherein the tie layer comprises at least one of an amino-functional epoxy resin or a hydroxyl-functional epoxy resin; and
(d) applying a polymeric layer adjoining the tie layer, wherein the polymeric layer comprises an isocyanate-functional polymer.

In certain embodiments, at least one of the primer layer, the tie layer or the polymeric layer is applied from an organic solvent. In some exemplary embodiments, the method further comprises heating at least one of the primer layer, the tie layer or the polymeric layer to remove at least a portion of the organic solvent. In some presently preferred embodiments, at least one of the primer layer, the tie layer or the polymeric layer is applied by spray coating. In other exemplary embodiments, the polymeric layer is applied by laminating a polymeric film comprising the isocyanate-functional polymer to the tie layer.

In another aspect, the disclosure relates to a method of lapping using the above-described double-sided coated carrier embodiments, the method comprising:
(a) providing a double-sided lapping machine having two opposed lapping surfaces or a single-sided lapping machine;
(b) providing the carrier of any of the above descriptions, comprising a base carrier having a first major surface, a second major surface and at least one aperture for holding a workpiece, said aperture extending from the first major surface through the base carrier to the second major surface, wherein the circumference of said aperture is defined by a third surface of the base carrier, and further wherein at least a portion of the first major surface or at least a portion of each of the first and the second major surfaces comprises a polymeric region, said polymeric region comprising at least the following adhesion promoting layers:
   (1) a primer layer, wherein the primer layer comprises at least one of a phenolic resin or a novolac resin;
   (2) a tie layer adjoining the primer layer, wherein the tie layer comprises at least one of an amino-functional epoxy resin or a hydroxyl-functional epoxy resin; and
   (3) a polymeric layer adjoining the tie layer on a side opposite the primer layer, wherein the polymeric layer comprises an isocyanate-functional polymer;
(c) providing a workpiece;
(d) inserting the workpiece into the aperture;
(e) inserting the carrier into the lapping machine;
(f) providing relative motion between the workpiece and the lapping surface while maintaining contact between the lapping surface and the workpiece; and
(g) removing at least a portion of the workpiece.

In some exemplary embodiments, a working fluid is provided at the interface between the workpiece and the lapping surfaces, optionally wherein the working fluid comprises abrasive particles. In certain exemplary embodiments, the lapping machine is a double-sided lapping machine having two opposed lapping surfaces and further comprising providing relative motion between the workpiece and the two opposed lapping surfaces while maintaining contact between the lapping surfaces and the workpiece. In other exemplary embodiments, at least one of the two opposed lapping surfaces comprises a three-dimensional, textured, fixed-abrasive article. In further exemplary embodiments, the three-dimensional, textured, fixed-abrasive article comprises diamond particles and/or agglomerates disposed in a binder. In additional exemplary embodiments, at least one of the two opposed lapping surfaces comprises pellet laps.

In certain embodiments, the method employs three-dimensional, textured, fixed-abrasive articles comprising diamond particles disposed in a binder as at least one of the two opposed surfaces of the lapping machine. In some embodiments, the method of the invention employs three-dimensional, textured, fixed-abrasive articles comprising diamond agglomerates disposed in a binder as at least one of the two opposed surfaces of the lapping machine. In some embodiments, the method employs three-dimensional, textured, fixed-abrasive articles comprising diamond agglomerates disposed in a binder wherein the diamond agglomerates comprise a binder different from the binder of the three-dimensional, textured, fixed-abrasive article.

In yet other embodiments, the disclosed method employs pellet laps on at least one of the two opposed lapping surfaces of the lapping machine. In some embodiments, the double-sided lapping machine is replaced by a single-sided lapping machine and the base carrier includes at least one polymeric region on the surface of the carrier which contacts the abrasive surface of the lapping machine.

Various modifications and alterations of this invention will become apparent to those skilled in the art without departing from the scope and spirit of this invention, and it should be understood that the invention is not to be unduly limited to the illustrative embodiments set forth herein as follows.

### EXAMPLES

Exemplary embodiments have been described above and are further illustrated below by way of the following Examples, which are not to be construed in any way as imposing limitations upon the scope of the presently described invention. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Where not otherwise specified, materials were available from chemical supply houses, such as Aldrich, Milwaukee, Wis.

### Materials

| | |
|---|---|
| C219 | Chemlock ™ 219, a mixed polymer adhesive for bonding |
| | castable urethane elastomers to metals, available from Lord |
| | Corporation (Cary, NC) (“Lord”). |
| C213 | Chemlock ™ 213, a mixed polymer primer/adhesive to bond |
| | castable urethane elastomers to metals, available from Lord. |
| MEK | Methyl Ethyl Ketone (2-butanone), a solvent available from |
| | Aldrich Chemical Co., Milwaukee, WI |
| T248 | Thinner 248, a solvent mixture, available from Lord Corp. |
| | (Cary, NC). |
| PMMEA | 1,2-Propanediol monomethylether acetate, a solvent available |
| | from Aldrich Chemical Co., Milwaukee, WI |
| E828 | Epon ™ 828, a bisphenol A diglycidyl ether available from the |
| | Miller-Stephenson Chemical Company, Inc. (Danbury, CT). |
| V125 | Versamid ™ 125, a reactive polyamide resin, available from |
| | Cognis Corp. (Cincinnati, OH). |
| C7604 | Coat-O-Sil ™ 7604 (formerly known as Silwet ™ L-7604), a |
| | silicone-functional polyether wetting agent available from |
| | Momentive Performance Materials (Albany, NY) |
| Dow 7 | Dow Additive 7 ™, a wetting agent, available from Dow |
| | Chemical Corp. (Midland, MI). |
| L83 | Adiprene ™ L83, a TDI - terminated polyether based prepolymer |
| | available from Chemtura Corp. (Middlebury, CT). |
| E300 | Ethacure ™ 300, a liquid aromatic diamine which is a mixture of |
| | the 2,4- and 2,6- isomers of dimethylthiotoluenediamine |
| | available from Albemarle, Corp. (Baton Rouge, LA.) |
| E100 | Ethacure ™ 100, a liquid aromatic diamine which is a mixture of |
| | the 2,4- and 2,6- isomers of dimethylthiotoluenediamine |
| | available from Albemarle, Corp., Baton Rouge, LA. |
| C-515-71HR | C-515-71HR, an adhesion promoter, available from Chartwell, |
| | International, Inc. (North Attleboro, MA). |
| M5 | Cab-O-Sil ™ M5 available from Cabot Corp (Tuscula, IL). |
| SK6233 | SCOTCHKOTE ™ 6233, available from 3M Company (St. Paul, |
| | MN) |
| C213A | A solution of 49.95% C213, 49.95% MEK, and 0.1% Dow 7 (all |
| | percentages based on weight). |
| C213B | A solution of 50% C213 and 50% T248 (all percentages based |
| | on weight). |
| C219A | A solution of 49.95% C219, 49.95% isopropanol, and 0.1% |
| | Dow 7 (all percentages based on weight). |
| Urethanel | A two part urethane coating consisting of 10 g MEK, 36.0 g L83 |
| | and 3.6 g of a premix of 82.00% E300, 16.30% titanium dioxide, |
| | 0.43% M5 and 1.27% Dow 7 (all % based on weight). |
| E58219 | A 75 μm thick thermoplastic urethane film, Estane ™ 58219, |
| | commercially available from Lubrizol Corp. (Wickliffe, OH). |
| PE1 | A 1.4 mil (35.6 μm) thick polyethylene terephthalate film. |
| Moleculok | An 80/20% w/w solution of a Phenolic Resin with a Cresol |
| DiBlend | Catechol Novolac (CCN) resin in an organic solvent (3M |
| | Company, St. Paul, MN) |

### Carrier Stripping and Surface Preparation

The following steps were carried to prepare the carrier surfaces for coating:
1. Strip carrier in concentrated 3M Citrus Stripper Gel (3M Company, St. Paul, Minn.), soaking carrier in Stripper Gel overnight.
2. Scrape off all of old urethane coating (if any).
3. Rinse off carrier with tap water.
4. Remove adhered epoxy and primer using a right angle die grinder and a 2″, green Roloc™ Bristle Disc (3M Company, St. Paul, Minn.).
5. Briefly polish with a 3M Stripper Pad (3M Company, St. Paul, Minn.) mounted on a 5″ Random Orbital Sander.
6. Store carrier overnight.
7. On the morning of the coating day, briefly polish the carrier with a 3M Stripper Pad (3M Company, St. Paul, Minn.) mounted on a 5″ Random Orbital Sander.
8. Wipe off the carriers with a clean cotton cloth soaked in MEK.
9. Mask large holes with 4¼″ blue 3M masking tape (3M Company, St. Paul, Minn.).
10. Wipe off the carriers with a clean cotton cloth soaked in MEK just before mounting carrier on the spray painting board.

### Carrier Coating and Curing

The following detailed steps and procedures were carried out in preparing the Examples. All percentages are expressed as percentages by weight of the particular component in the composition, unless otherwise indicated.

In the following examples, all coatings were applied to the base carrier as a spray coating applied from an organic solvent. All spray coating was done with a 3M Paint Spray gun using 3M 16000 Paint Preparation System (3M Company, St. Paul, Minn.). The supply air to the gun was set to 60 psig. The pressure at the nozzle was maintained at 29 psig during spraying so that the conditions are consistent with High Volume Low Pressure (HVLP) practices.

### Example 1

### Primer

1. Spray eight passes of the following primer formulation on the first side of the carrier:

| | |
|---|---|
| C219 | 50.0% |
| Methanol | 50.0% |

Allow to air dry for approximately 10 minutes.

2. Spray eight passes of the following primer formulation on the second side of the carrier:

| | |
|---|---|
| C219 | 50.0% |
| Methanol | 50.0% |

Allow to air dry for approximately 10 minutes.

### Adhesive (Tie Layer)

3. Spray 16 passes of the following adhesive formulation over the first side of the carrier:

| | |
|---|---|
| C213 | 50.0% |
| T248 | 50.0% |

Allow to air dry for approximately 10 minutes.

4. Spray 16 passes of the following adhesive formulation over the second side of the carrier:

| | |
|---|---|
| C213 | 50.0% |
| T248 | 50.0% |

Allow to air dry for approximately 10 minutes.

5. Dry and partially cure in a walk-in oven at 120° C. for 30 minutes.

### Urethane

6. Spray 15 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

7. Dry and partially cure in a walk-in oven at 120° C. for 3 minutes.
8. Spray 15 passes of the preceding urethane formulation over the first side of the carrier.
9. Dry and cure in walk-in oven for 15 minutes at 120° C.
10. Spray 15 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

11. Dry and partially cure in a walk-in oven at 120° C. for 3 minutes.
12. Spray 15 passes of the preceding urethane formulation over the second side of the carrier.
13. Dry and cure in walk-in oven for 5 hours at 120° C., then 12 hours at 90° C.

### Example 2

### Primer

1. Spray eight passes of the following primer formulation on the first side of the carrier:

| | |
|---|---|
| C219 | 50.0% |
| Methanol | 50.0% |

Allow to air dry for approximately 10 minutes.

2. Spray eight passes of the following primer formulation on the second side of the carrier:

| | |
|---|---|
| C219 | 50.0% |
| Methanol | 50.0% |

Allow to air dry for approximately 10 minutes.

### Adhesive (Tie Layer)

3. Spray 16 passes of the following adhesive formulation over the first side of the carrier:

| | |
|---|---|
| C213 | 50.0% |
| T248 | 50.0% |

Allow to air dry for approximately 10 minutes.

4. Spray 16 passes of the following adhesive formulation over the second side of the carrier:

| | |
|---|---|
| C213 | 50.0% |
| T248 | 50.0% |

Allow to air dry for approximately 10 minutes.

5. Dry and partially cure in a walk-in oven at 120° C. for 30 minutes.

### Urethane

6. Spray 30 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

7. Dry and cure in walk-in oven for 15 minutes at 120° C.
8. Spray 30 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

9. Dry and cure in walk-in oven for 17 hours at 120° C.

### Example 3

### Primer

1. Spray eight passes of the following primer formulation on the first side of the carrier:

| | |
|---|---|
| C219 | 50.0% |
| Methanol | 50.0% |

Allow to air dry for approximately 10 minutes.

2. Spray eight passes of the following primer formulation on the second side of the carrier:

| | |
|---|---|
| C219 | 50.0% |
| Methanol | 50.0% |

Allow to air dry for approximately 10 minutes.

### Adhesive (Tie Layer)

3. Spray 16 passes of the following adhesive formulation over the first side of the carrier:

| | |
|---|---|
| C213 | 50.0% |
| T248 | 50.0% |

Allow to air dry for approximately 10 minutes.

4. Spray 16 passes of the following adhesive formulation over the second side of the carrier:

| | |
|---|---|
| C213 | 50.0% |
| T248 | 50.0% |

Allow to air dry for approximately 10 minutes.

5. Dry and partially cure in a walk-in oven at 120° C. for 30 minutes.

### Urethane

6. Spray 15 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

7. Dry and partially cure in a walk-in oven at 120° C. for 3 minutes.
8. Spray 15 passes of the previous urethane formulation (formed upon mixing Parts A and B) over the first side of the carrier.
9. Dry and cure in walk-in oven for 15 minutes at 120° C.
10. Spray 15 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

11. Dry and partially cure in a walk-in oven at 120° C. for 3 minutes.
12. Spray 15 passes of the preceding urethane formulation over the second side of the carrier.
13. Dry and cure in walk-in oven for 5 hours at 120° C., then 12 hours at 90° C.

### Example 4

### Primer

1. Spray eight passes of the following primer formulation on the first side of the carrier:

| | |
|---|---|
| C219 | 50.0% |
| Methanol | 50.0% |

Allow to air dry for approximately 10 minutes.

2. Spray eight passes of the following primer formulation on the second side of the carrier:

| | |
|---|---|
| C219 | 50.0% |
| Methanol | 50.0% |

Allow to air dry for approximately 10 minutes.

### Adhesive (Tie Layer)

3. Spray 16 passes of the following adhesive formulation over the first side of the carrier:

| | |
|---|---|
| C213 | 50.0% |
| T248 | 50.0% |

Allow to air dry for approximately 10 minutes.

4. Spray 16 passes of the following adhesive formulation over the second side of the carrier:

| | |
|---|---|
| C213 | 50.0% |
| T248 | 50.0% |

Allow to air dry for approximately 10 minutes.

5. Dry and partially cure in a walk-in oven at 120° C. for 30 minutes.

### Urethane

6. Spray 30 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

7. Dry and cure in walk-in oven for 15 minutes at 120° C.
8. Spray 30 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

9. Dry and cure in walk-in oven for 17 hours at 120° C.

### Example 5

### Primer

1. Spray eight passes of the following primer formulation on the first side of the carrier:

| | |
|---|---|
| Moleculok Diblend | 25.0% |
| MEK | 12.5% |
| PMMEA | 12.5% |
| Methanol | 50.0% |

Allow to air dry for approximately 10 minutes.

2. Spray eight passes of the following primer formulation on the second side of the carrier:

| | |
|---|---|
| Moleculok Diblend | 25.0% |
| MEK | 12.5% |
| PMMEA | 12.5% |
| Methanol | 50.0% |

Allow to air dry for approximately 10 minutes.

### Adhesive (Tie Layer)

3. Spray 16 passes of the following adhesive formulation (formed upon mixing Parts A, B and C) over the first side of the carrier:

| Part A Premix | (200.0 g) |
|---|---|
| E828 | 50.0% |
| MEK | 25.0% |
| PMMEA | 25.0% |
| Part B Premix | (90.9 g) |
| E100 | 48.0% |
| C7604 | 1.0% |
| Dow 7 | 1.0% |
| PMMEA | 50.0% |
| Part C Premix | (50.0 g) |
| L83 | 60.0% |
| MEK | 40.0% |

Allow to air dry for approximately 10 minutes.

4. Spray 16 passes of the following adhesive formulation (formed upon mixing Parts A, B and C) over the second side of the carrier:

| Part A Premix | (200.0 g) |
|---|---|
| E828 | 50.0% |
| MEK | 25.0% |
| PMMEA | 25.0% |
| Part B Premix | (90.9 g) |
| E100 | 48.0% |
| C7604 | 1.0% |
| Dow 7 | 1.0% |
| PMMEA | 50.0% |
| Part C Premix | (50.0 g) |
| L83 | 60.0% |
| MEK | 40.0% |

Allow to air dry for approximately 10 minutes.

5. Dry and partially cure in a walk-in oven at 120° C. for 30 minutes.

### Urethane

6. Spray 15 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

7. Dry and partially cure in a walk-in oven at 120° C. for 3 minutes.
8. Spray 15 passes of the preceding urethane formulation on the first side of the carrier.
9. Dry and cure in walk-in oven for 15 minutes at 120° C.
10. Spray 15 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

11. Dry and partially cure in a walk-in oven at 120° C. for 3 minutes.
12. Spray 15 passes of the preceding urethane formulation over the second side of the carrier.
13. Dry and cure in walk-in oven for 5 hours at 120° C., then 12 hours at 90° C.

### Example 6

### Primer

1. Spray eight passes of the following primer formulation on the first side of the carrier:

| | |
|---|---|
| Moleculok Diblend | 25.0% |
| MEK | 12.5% |
| PMMEA | 12.5% |
| Methanol | 50.0% |

Allow to air dry for approximately 10 minutes.

2. Spray eight passes of the following primer formulation over the second side of the carrier:

| | |
|---|---|
| Moleculok Diblend | 25.0% |
| MEK | 12.5% |
| PMMEA | 12.5% |
| Methanol | 50.0% |

Allow to air dry for approximately 10 minutes.

### Adhesive (Tie Layer)

3. Spray 16 passes of the following adhesive formulation (formed upon mixing Parts A and B) over the first side of the carrier:

| Part A Premix | (200.0 g) |
|---|---|
| E828 | 50.0% |
| MEK | 25.0% |
| PMMEA | 25.0% |
| Part B Premix | (90.9 g) |
| E100 | 48.0% |
| C7604 | 1.0% |
| Dow 7 | 1.0% |
| PMMEA | 50.0% |
| Part C Premix | (50.0 g) |
| L83 | 60.0% |
| MEK | 40.0% |

Allow to air dry for approximately 10 minutes.

4. Spray 16 passes of the following adhesive formulation (formed upon mixing Parts A, B and C) over the second side of the carrier:

| Part A Premix | (200.0 g) |
|---|---|
| E828 | 50.0% |
| MEK | 25.0% |
| PMMEA | 25.0% |
| Part B Premix | (90.9 g) |
| E100 | 48.0% |
| C7604 | 1.0% |
| Dow 7 | 1.0% |
| PMMEA | 50.0% |
| Part C Premix | (50.0 g) |
| L83 | 60.0% |
| MEK | 40.0% |

Allow to air dry for approximately 10 minutes.

5. Dry and partially cure in a walk-in oven at 120° C. for 30 minutes.

### Urethane

6. Spray 15 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

7. Dry and partially cure in a walk-in oven at 120° C. for 3 minutes.
8. Spray 15 passes of the preceding urethane formulation over the first side of the carrier.
9. Dry and cure in walk-in oven for 15 minutes at 120° C.
10. Spray 15 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

11. Dry and partially cure in a walk-in oven at 120° C. for 3 minutes.
12. Spray 15 passes of the preceding urethane formulation over the second side of the carrier.
13. Dry and cure in walk-in oven for 17 hours at 120° C.

### Example 7

### Comparative

### Adhesive/Primer

1. Spray eight passes of the following adhesive/primer formulation on the first side of the carrier:

| | |
|---|---|
| SK6233 | 50.0% |
| MEK | 25.0% |
| PMMEA | 25.0% |

Allow to air dry for approximately 10 minutes.

2. Spray eight passes of the following adhesive/primer formulation on the second side of the carrier:

| | |
|---|---|
| SK6233 | 50.0% |
| MEK | 25.0% |
| PMMEA | 25.0% |

Allow to air dry for approximately 10 minutes.

3. Dry and partially cure in a walk-in oven at 120° C. for 30 minutes.

### Urethane

4. Spray 15 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

5. Dry and partially cure in a walk-in oven at 120° C. for 3 minutes.
6. Spray 15 passes of the preceding urethane formulation over the first side of the carrier.
7. Dry and cure in walk-in oven for 15 minutes at 120° C.
8. Spray 15 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

9. Dry and partially cure in a walk-in oven at 120° C. for 3 minutes.
10. Spray 15 passes of the preceding urethane formulation over the second side of the carrier.
11. Dry and cure in walk-in oven for 5 hours at 120° C., then 12 hours at 90° C.

### Example 8

### Comparative

### Adhesive/Primer

1. Spray eight passes of the following adhesive/primer formulation on the first side of the carrier:

| | |
|---|---|
| SK6233 | 50.0% |
| MEK | 25.0% |
| PMMEA | 25.0% |

Allow to air dry for approximately 10 minutes.

2. Spray eight passes of the following adhesive/primer formulation on the second side of the carrier:

| | |
|---|---|
| SK6233 | 50.0% |
| MEK | 25.0% |
| PMMEA | 25.0% |

Allow to air dry for approximately 10 minutes.

3. Dry and partially cure in a walk-in oven at 120° C. for 30 minutes.

### Urethane

4. Spray 15 passes of the following urethane formulation (formed upon mixing Parts A and B) over the first side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

5. Dry and partially cure in a walk-in oven at 120° C. for 3 minutes.
6. Spray 15 passes of the preceding urethane formulation over the first side of the carrier.
7. Dry and cure in walk-in oven for 15 minutes at 120° C.
8. Spray 15 passes of the following urethane formulation (formed upon mixing Parts A and B) over the second side of the carrier:

| Part A Premix | (375.0 g) |
|---|---|
| L83 | 60.0% |
| MEK | 40.0% |
| Part B Premix | (37.9 g) |
| E300 | 51.0% |
| C7604 | 4.5% |
| Dow 7 | 4.5% |
| MEK | 40.0% |

9. Dry and partially cure in a walk-in oven at 120° C. for 3 minutes.
10. Spray 15 passes of the preceding urethane formulation over the second side of the carrier.
11. Dry and cure in walk-in oven for 17 hours at 120° C.

Examples 1-4 used C219 as a primer layer on the metal carrier with a C213 tie layer bonding the Adiprene L83 and E300 (or E100) urethane polymer layer to the primer layer. Examples 1 and 2 had only five hours of cure time at 120° C. Examples 3 and 4 had seventeen hours of cure time at 120° C. The additional cure time at the higher temperature appears to improve the performance of the multi-layer APS.

Examples 5 and 6 used the Moleculok Diblend as a primer layer on the metal carrier. An epoxy tie layer containing Epon 828 and Ethacure 100 bonded well to the primer layer, and to the Adiprene L83 and E300 urethane polymer layer. Examples 5 and 6 adhered well to the steel carrier surface. The adhesion was so good that the standard process for removing the urethane coating, an overnight soak in 3M H22 Floor Stripper (3M Company, St. Paul, Minn.), did not cause the urethane layer to swell and release from the surface. The coating had to be ground off with a 3M green bristle abrasive disc using a right angle die grinder.

Examples 7 and 8 are Comparative Examples using an adhesive/primer layer without an intermediate tie layer. The primer layer was SCOTCHKOTE 6233 adhesive, and the polymer layer was Adiprene L83 and E300 polyurethane. Examples 7 and 8 failed due to delamination of the polymer layer from the adhesive/primer layer.

### Test Methods

### Test Method 1, Adhesion

A test method was developed to examine the adhesion of urethane coatings to the surface of stainless steel coupons. Two coupons of each example were soaked in deionized water at 53° C. for 2 hours. After soaking, any coating that was not delaminated or that could not be easily peeled away from the stainless steel was considered to have passed the test. One coupon of the two was required to meet these criteria for an example to pass.

### Test Method 2, Polishing

Carriers were tested using a Peter-Wolters AC500 (Peter-Wolters of America, Des Plaines, Ill.) double-sided lapping machine to polish 800 μm thick, 100 mm diameter silicon wafers. A polishing cycle involved the simultaneous polishing of three wafers each inserted within its own carrier for a 10 min. polishing time. The carrier rotation was alternated from clockwise (CW) to counterclockwise (CCW) with each polishing cycle, starting with clockwise rotation. The machine was operated at a platen speed of 96 rotations per minute (rpm) and a pressure of 9.65 kPa (1.4 psi) with the sun gear (inner ring) at 14 rpm. Deionized water was supplied at 500 mL/min. to provide cooling and swarf removal. The fixed abrasive pads were 4A-DT 6-015 Trizact™ Diamond Tile (3M Company, St. Paul, Minn.) which were conditioned, before and between successive tests, by running annular 600 grit aluminum oxide stones, one minute CW and one minute CCW to establish comparable initial states of the pad surfaces for each test. Removal rates of the wafers were determined gravimetrically. Unless otherwise noted, data is the average of the three wafers per cycle. Uniformity of the removal rate relative to the top wafer surface and bottom wafer surface was monitored by visually observation. Visual asymmetry of the wafer edge profile after polishing indicated asymmetry in the polishing rate, i.e., the removal rate differed between the top and bottom surfaces of the wafer.

### Test Method 3, Tensile

A tensile test method was used to determine mechanical properties of films. The test generally followed ASTM D638 except that a sample gauge length of 25 mm and a sample width of 25 mm were used with a crosshead speed of 101.6 cm/min. (40 inches/min.).

### Test Method 4, Wear

Test method 4 subjects the polymeric layer coated carriers to an accelerated wear test using both a soaking step in an aqueous solution including deionized water, and a single-sided lapping step. The aqueous solution contained silicon swarf from a previous grinding operation on a silicon wafer. The soaking step involved submerging the carrier in the aqueous solution containing less than 0.5% by weight of silicon swarf and deionized water at 60° C. for four days. The lapping process was conducted on a Peter-Wolters AC500™ tool (Peter Wolters, GmbH, Rendsburg, Germany).

A fixed abrasive pad, 4A-DT 6-015 Trizact™ Diamond Tile (available from 3M Company, St. Paul, Minn.) was mounted on the lower platen. Each carrier was mounted on the platen, with the teeth of the carrier engaging the inner and outer ring pins. A 100 mm diameter silicon wafer was mounted in the carrier. Two 3.3 kg gears of the same outer geometry as the carriers being tested having an inside diameter of 124.8 mm were placed on top of the test carrier. Four 1.13-kg plates were placed on the center of the carrier, inside the ring gears. Two 4.5 kg plates were then placed on top of the ring gears. The 4.5 kg plates did not contact the four, 1.13-kg plates in the center of the carrier. The total weight on the center of the carrier was about 4.5 kg with the total weight on the carrier being about 20 kg. The contact area of the carrier was about 165 cm², yielding an average pressure on the carrier of about 0.12 kg/cm².

The AC500's lower platen was rotated at 96 rpm and its sun gear was rotated at 14 rpm. The working fluid used in the test was a recycled, aqueous solution containing silicon swarf from a previous grinding process. The previous grinding process was a double sided lapping process using a 6 μm diamond abrasive, a 4A-DT 6-015 Trizact™ Diamond Tile pad (3M Company) to grind silicon wafers. The recycled, aqueous solution contained less than about 0.5% silicon by weight. The test time for Test Method 4 was 10 minutes, after which, the platen and gear rotation was stopped, the weights removed from the carriers and the carriers removed from the tool. The carriers were examined visually for delamination of the polymeric layer.

The test results were as follows:

TABLE 1

| | | Soaked 4 Days | Weighted Wear Test |
|---|---|---|---|
| Example | Carrier | at 60° C. | Results |
| 1 | Steel | Good | Delamination around |
| | | | Work Hole |
| 2 | Steel | Good | Delamination around |
| | | | Work Hole |
| 3 | Steel | Good | Delamination around |
| | | | Work Hole |
| 4 | Steel | Good | Good |
| 5 | Steel | Good | Good |
| 6 | Steel | Good | Good |
| 7 (Comparative) | Steel | Good | Good Wear, but |
| | | | Delaminated |
| 8 (Comparative) | Steel | Good | Good Wear, but |
| | | | Delaminated |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the presently described invention. Thus, the appearances of the phrases such as “in one or more embodiments,” “in certain embodiments,” “in one embodiment” or “in an embodiment” in various places throughout this specification are not necessarily referring to the same embodiment of the presently described invention. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term ‘about’. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A lapping carrier comprising a base carrier having a first major surface, a second major surface and at least one aperture for holding a workpiece, said aperture extending from the first major surface through the base carrier to the second major surface, wherein the circumference of said aperture is defined by a third surface of the base carrier, and further wherein at least a portion of the first major surface or at least a portion of each of the first and the second major surfaces comprises a polymeric region, said polymeric region comprising at least the following adhesion promoting layers:
(a) a primer layer, wherein the primer layer comprises at least one of a phenolic resin or a novolac resin;
(b) a tie layer adjoining the primer layer, wherein the tie layer comprises at least one of an amino-functional epoxy resin or a hydroxyl-functional epoxy resin; and
(c) a polymeric layer adjoining the tie layer on a side opposite the primer layer, wherein the polymeric layer comprises an isocyanate-functional polymer.

2. The carrier of claim 1 wherein both of the first major surface and the second major surface comprise the polymeric region.

3. (canceled)

4. The carrier of claim 1 wherein the base carrier comprises metal, glass, filled polymer, or ceramic.

5. The carrier of claim 1, wherein when the primer layer comprises a novolac resin, the novolac resin is selected from a catechol novolac resin, a cresol novolac resin, a polyhydroxyphenol-endcapped novolac resin, or combinations thereof and, wherein when the primer layer comprises a phenolic resin, the phenolic resin is selected from a cresol phenolic resin, a resol phenolic resin, a polyhydroxy phenolic resin, a hydroxythiophenol phenolic resin, a polythiol phenolic resin, or combinations thereof.

6. (canceled)

7. The carrier of claim 1, wherein the primer layer is chemically bonded to at least one of the base carrier or the tie layer.

8. The carrier of claim 1, wherein the tie layer is chemically bonded to at least one of the primer layer or the polymeric layer.

9. (canceled)

10. The carrier of claim 1, wherein the polymeric layer comprises a polymeric coating or a laminated polymeric film.

11. The carrier of claim 1, wherein the isocyanate-functional polymer comprises a poly-functional urethane polymer.

12. The carrier of claim 11, wherein the isocyanate-functional polymer comprises a crosslinked urethane polymer.

13. The carrier of claim 1, wherein the polymeric region has a work to failure of at least about 15 Joules.

14. The carrier of claim 1 wherein the polymeric region includes a thermoset polymer, a thermoplastic polymer, a thermoset polyurethane, a thermoplastic polyurethane, or a combination thereof.

15. (canceled)

16. A method of lapping comprising:
(a) providing a double-sided lapping machine having two opposed lapping surfaces or a single-sided lapping machine;
(b) providing the carrier of any of the above claims comprising a base carrier having a first major surface, a second major surface and at least one aperture for holding a workpiece, said aperture extending from the first major surface through the base carrier to the second major surface, wherein the circumference of said aperture is defined by a third surface of the base carrier, and further wherein at least a portion of the first major surface or at least a portion of each of the first and the second major surfaces comprises a polymeric region, said polymeric region comprising at least the following adhesion promoting layers:
(1) a primer layer, wherein the primer layer comprises at least one of a phenolic resin or a novolac resin;
(2) a tie layer adjoining the primer layer, wherein the tie layer comprises at least one of an amino-functional epoxy resin or a hydroxyl-functional epoxy resin; and
(3) a polymeric layer adjoining the tie layer on a side opposite the primer layer, wherein the polymeric layer comprises an isocyanate-functional polymer;
(c) providing a workpiece;
(d) inserting the workpiece into the aperture;
(e) inserting the carrier into the lapping machine;
(f) providing relative motion between the workpiece and the lapping surface while maintaining contact between the lapping surface and the workpiece; and
(g) removing at least a portion of the workpiece.

17. The method of claim 16 further comprising providing a working fluid at the interface between the workpiece and the lapping surfaces, optionally wherein the working fluid comprises abrasive particles.

18. The method of claim 16 wherein the lapping machine is a double-sided lapping machine having two opposed lapping surfaces and further comprising providing relative motion between the workpiece and the two opposed lapping surfaces while maintaining contact between the lapping surfaces and the workpiece.

19-21. (canceled)

22. A method of making a coated lapping carrier comprising:
(a) providing a base carrier having a first major surface, a second major surface and at least one aperture for holding a workpiece, said aperture extending from the first major surface through the base carrier to the second major surface, wherein the circumference of said aperture is defined by a third surface of the base carrier;
(b) applying a primer layer to at least one surface of the base carrier, wherein the primer layer comprises at least one of a phenolic resin or a novolac resin;
(c) applying a tie layer adjoining the primer layer, wherein the tie layer comprises at least one of an amino-functional epoxy resin or a hydroxyl-functional epoxy resin; and
(d) applying a polymeric layer adjoining the tie layer, wherein the polymeric layer comprises an isocyanate-functional polymer.

23-26. (canceled)

27. The method of claim 22, wherein the primer layer, the tie layer and the polymeric layer are applied on at least a portion of both major surfaces.

28-31. (canceled)

32. The method of claim 22, wherein when the primer layer comprises a novolac resin, the primer layer is selected from a catechol novolac resin, a cresol novolac resin, a polyhydroxyphenol-endcapped novolac resin, or combinations thereof and wherein when the primer layer comprises a phenolic resin, the phenolic resin is selected from a cresol phenolic resin, a resol phenolic resin, a polyhydroxy phenolic resin, a hydroxythiophenol phenolic resin, a polythiol phenolic resin, or combinations thereof.

33-34. (canceled)

35. The method of claim 22, wherein the isocyanate-functional polymer comprises a poly-functional urethane polymer.

36. The method of claim 22, wherein the isocyanate-functional polymer comprises a crosslinked urethane polymer.

37. The method of claim 22, wherein the isocyanate-functional polymer has a work to failure of at least about 15 Joules.

38-39. (canceled)
